(19) United States
(12) Patent Application Publication
(10) Pub. No.: US 2020/0005197 A1
(43) Pub. Date: Jan. 2, 2020

(54) System and Method for Providing Driving Assistance

(71) Applicants: Lisa Bottcher, McHenry, IL (US); Mark Larson, Yorkville, IL (US)

(72) Inventors: Lisa Bottcher, McHenry, IL (US); Mark Larson, Yorkville, IL (US)

(21) Appl. No.: 16/023,337

(22) Filed: Jun. 29, 2018

(51) Int. Cl. G06Q 10/02; G01C 21/34; G06K 9/00

(52) U.S. Cl. CPC G06Q 10/02; G06Q 50/30; G06K 9/00845; G01C 21/3438

(57) ABSTRACT

A system and method for providing driving assistance allow a user to request a driver wherein a first requested driver drives the user and a second requested driver drives the user's vehicle to a destination provided by the user. Safety and security provisions are provided to ensure protection for both the user and the first and second drivers.

### TECHNICAL FIELD

The present invention relates to a system and method for providing driving assistance. Specifically, the system and method allow a user to request a pair of drivers wherein a first requested driver drives the user and a second requested driver drives the user's vehicle to a destination provided by the user. Safety and security provisions are provided to ensure protection for both the user and the first and second drivers.

### BACKGROUND

Driving while intoxicated is a massive problem around the world. Indeed, operating any heavy machinery while impaired often leads to injuries or death to others, and damage to property. According to the Centers for Disease Control, it is estimated that drunk driving accounted for about 10,500 deaths in 2016, which was about 28% of all driving related deaths in the United States. Statistics show that about 29 people per day die in traffic accidents caused by alcohol-impaired drivers. This accounts for about 1 death every 50 minutes in the United States.

Campaigns to decrease alcohol-impaired driving have shown little success in decreasing the number of alcohol-impaired drivers. Some campaigns attempt to educate others about the dangers of driving while intoxicated. However, oftentimes, being drunk impairs not only the ability to operate heavy machinery, but also to make proper judgments about driving while intoxicated. One particular campaign revolves around the “designated driver”, which is the declaration of a friend that will not imbibe at a bar, but will drive his or her friends' home at the end of the night that have been drinking. However, it is often difficult to get agreement as to who will be the designated driver, as the designated driver must not partake in any drinking. Moreover, even if designated, there is no guarantee that the designated driver will, actually, avoid alcohol or drugs. Passengers may believe that they are safe, when they are not.

Taxi cabs have existed for many years, and more recently ridesharing applications such as Uber and Lyft make it easier for those who are impaired to get rides home when out and impaired. However, while Uber and Lyft may take the requestor home at the end of an evening, there is typically nobody to drive the requestor's vehicle back to his or her home as well. Oftentimes, the requestor must then retrieve his or her vehicle from the establishment. In some cases, vehicles may become parked illegally when parked overnight, and may get towed, in which case the requestors must typically pay to get their vehicles back from an impound lot. In some extreme cases, vehicles left overnight may become vandalized or broken into, causing damage and loss to the requestor.

Moreover, a user of a taxicab or a ridesharing application may not be completely safe from the driver. There are reports of Uber and Lyft drivers attacking passengers, especially when the passengers are in an intoxicated condition. In April, 2018, a CNN report indicated that over the previous 4 years, 103 Uber drivers were accused of sexual assault or abuse. Stories like these discourage users from calling taxicabs and using ridesharing applications, leading to impaired decisions about driving their own vehicles. And moreover, many people are reticent about letting a stranger drive the user's vehicle home due to perceived lack of safety and security.

A need, therefore, exists for an improved system and method for providing driving assistance. Specifically, a need exists for an improved system and method that quickly and easily allows a user to signal a driver when the user cannot drive his or her vehicle.

Moreover, a need exists for an improved system and method for allowing a user to specify his or her location automatically to a driver for retrieval. Likewise, a need exists for an improved system and method for allowing a user to manually or automatically specify the location of his or her vehicle to a driver for retrieval of the same.

In addition, a need exists for an improved system and method for providing driving assistance that transports both a requestor and the requestor's vehicle to another location, typically to the requestor's home. Moreover, a need exists for an improved system and method for providing driving assistance that provide enhanced safety and security provisions to ensure that reduce the likelihood of injury or damage to the requestor or the requestor's vehicle by the drivers.

### SUMMARY OF THE INVENTION

The present invention relates to a system and method for providing driving assistance. Specifically, the system and method allow a user to request a driver wherein a first requested driver drives the user and a second requested driver drives the user's vehicle to a destination provided by the user. Safety and security provisions are provided to ensure protection for both the user and the first and second drivers.

To this end, in an embodiment of the present invention, a method for assisting a driver is provided. The method comprises the steps of: providing a server supporting an application, wherein the application facilitates communication between a first mobile device and a second mobile device, wherein the first mobile device is carried by a first user of the application and the second mobile device is carried by a second user of the application; inputting location information about a first user's vehicle to the first mobile device; accessing a communication portal at the first mobile device by the first user, wherein accessing the communication portal establishes a connection between the first mobile device and the application on the server; sending a first communication to the application from the first mobile device requesting pick-up at a pick-up location, wherein the first communication further provides the location information about the first user's vehicle, the pick-up location, and location information about the first user's destination; and sending a second communication from the application to the second mobile device, wherein the second mobile device is within a second vehicle comprising first and second drivers, wherein the second communication informs the second mobile device about the pick-up location, the location information about the first user's vehicle, and the location information about the first user's destination, wherein the second vehicle picks up the first user at the second location, and further wherein the first driver in the second vehicle drives the first user's vehicle from the location of the first user's vehicle to the first user's destination, and the first user rides in the second vehicle to the first user's destination driven by the second driver.

In an embodiment, the pick-up location is the same location as the location of the first user's vehicle.

In an embodiment, the location information of the first user's vehicle is manually input by the first user into the first mobile device.

In an embodiment, the location information of the first user's vehicle is automatically entered into the first mobile device.

In an embodiment, the location information of the first user's vehicle is automatically entered into the first mobile via location tracking means of the first mobile device.

In an embodiment, the location information of the first user's vehicle is determined by the application via information input into the first mobile device.

In an embodiment, the information input into the first mobile device is interpreted by the application to indicate when the first user exits the first vehicle after driving the first vehicle.

In an embodiment, the information input into the first mobile device comprises location information about the first mobile device, and information informing the first mobile device that the first user has parked the vehicle.

In an embodiment, the method further comprises the step of: automatically requesting pick-up by the second user when the application detects that the first user is impaired.

In an embodiment, the detection that the first user is impaired comprises analyzing first user data selected from the group consisting of location tracking information about the first user, audio data, video data, and combinations thereof.

In an embodiment, the method further comprises the step of: recording drive data as the first driver drives the first vehicle to the first user's destination and the second driver drives the second vehicle and the first user to the first user's destination.

In an embodiment, the drive data is recorded from at least one camera mounted on the second vehicle.

In an embodiment, the at least one camera mounted on the second vehicle is selected from the group consisting of a portable camera and a permanently mounted camera.

In an embodiment, the drive data is recorded from at least one camera mounted within the first vehicle.

In an embodiment, the at least one camera mounted within the first vehicle is selected from the group consisting a portable camera and a permanently mounted camera.

In an embodiment, the at least one camera mounted within the first vehicle is placed by the first driver upon entering the first vehicle.

In an embodiment, the drive data is recorded from at least one camera mounted within the first vehicle and at least one camera mounted within the second vehicle.

In an embodiment, the drive data is recorded from a drone flying above the first vehicle and the second vehicle as the first driver drives the first vehicle and the second driver drives the second vehicle.

In an embodiment, the drive data comprises video information from the drone.

In an embodiment, the drone is launched from the second vehicle when the first driver drives the first vehicle to the user's destination.

It is, therefore, an advantage and objective of the present invention to provide an improved system and method for providing driving assistance.

Specifically, it is an advantage and objective of the present invention to provide an improved system and method that quickly and easily allows a user to signal a driver when the user cannot drive his or her vehicle.

Moreover, it is an advantage and objective of the present invention to provide an improved system and method for allowing a user to specify his or her location automatically to a driver for retrieval.

Likewise, it is an advantage and objective of the present invention to provide an improved system and method for allowing a user to manually or automatically specify the location of his or her vehicle to a driver for retrieval of the same.

In addition, it is an advantage and objective of the present invention to provide an improved system and method for providing driving assistance that transports both a requestor and the requestor's vehicle to another location, typically to the requestor's home.

Moreover, it is an advantage and objective of the present invention to provide an improved system and method for providing driving assistance that provide enhanced safety and security provisions to ensure that reduce the likelihood of injury or damage to the requestor or the requestor's vehicle by the drivers.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a graphical representation of a system for providing driving assistance in an embodiment of the present invention.

FIG. 2 illustrates a smart phone for flagging a location of a vehicle in an embodiment of the present invention.

FIG. 3 illustrates a representation of a Driver Pair vehicle following a User vehicle and having one or more cameras thereon in an embodiment of the present invention.

FIG. 4 illustrates a representation of an internal compartment of a vehicle having one or more cameras therein in an embodiment of the present invention.

FIG. 5 illustrates a representation of a Driver Pair vehicle following a User vehicle and having a drone for capturing data in an embodiment of the present invention.

### DETAILED DESCRIPTION OF THE PRESENTLY PREFERRED EMBODIMENTS

The present invention relates to a system and method for providing driving assistance. Specifically, the system and method allow a user to request a driver wherein a first requested driver drives the user and a second requested driver drives the user's vehicle to a destination provided by the user. Safety and security provisions are provided to ensure protection for both the user and the first and second drivers.

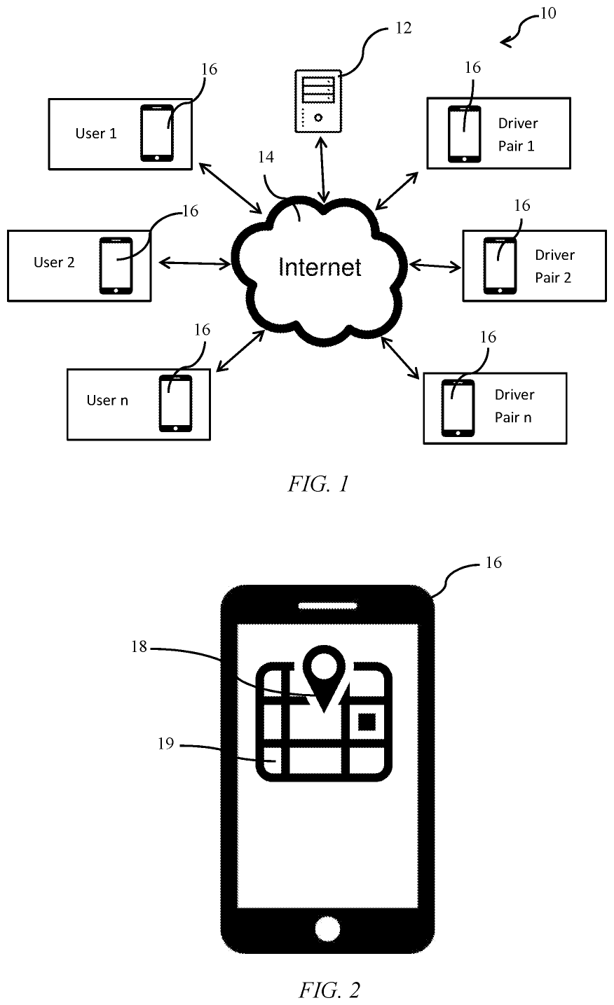

Now referring to the figures, wherein like numerals refer to like parts, FIG. 1 illustrates a graphical representation of a system 10 for providing driving assistance to users in an embodiment of the present invention. A server 12 hosts a software application that may be implemented to accomplish the steps of the present invention. Specifically, the server 12 comprises a software application that may be utilized by Users (designated as User 1, User 2, User n . . . ) of the present invention to easily and efficiently obtain driving assistance, and by Driver Pairs (designated as Driver Pair 1, Driver Pair 2, Driver Pair n . . . )

The Users and the Driver Pairs may have access to the software application resident on the server 12 via the Internet 14, either via a webpage or through a portal resident on his or her mobile devices 16. The software application resident on server 12 may require login credentials to access the software application and its functionality.

Each User or Driver Pair may access the internet 14 via his or her mobile device 16 through connection means apparent to one of ordinary skill in the art, but mainly via cellular communication protocol, via WIFI, or via any other known communication protocol. In addition, each User and/or Driver Pair may have location-finding means, such as via GPS or cellular tower triangulation so that the location of the mobile device 16 of the Users and/or Driver Pairs may be tracked, thereby aiding Driver Pairs in locating Users, when necessary, as described in more detail below, and to select nearby Driver Pairs that may be available to assist a User.

It should be noted that the application through which the present invention may be implemented may be any combination of software and hardware, and the present invention should not be limited as described herein. For example, location detecting means may be implemented via software resident on a mobile device, interacting with one or more antennas that triangulate position based on calculated distance from GPS satellites or cellular towers. Moreover, portions of software and hardware may be contained on server 12 or one or more servers, but may also be resident on the mobile devices 16 of the Users and the Driver Pairs to provide communication between the mobile devices 16 and the server 12, and to implement the transfer of information, as necessary.

In an embodiment of the present invention, a User may activate his or her mobile device and software resident thereon, or via URLs over webpages, to request a pick-up from a Driver Pair. For example, the User may be at a party or a bar, and may have had too much to drink, and may thereby know not to drive his or her vehicle while in such a state.

Upon requesting a Driver Pair, the system may query the User with several options for when the pick-up should occur. For example, the system may request whether the User wishes to be picked up immediately, whether the User wishes to be picked up shortly (such as after “one more drink”), whether the User wishes to be picked up at a certain time in the future (such as, for example, at 11 pm), or whether the User wishes to be picked up a certain amount of time in the future (such as “two hours later”).

The system of the present invention may then determine the location of the User via his or her mobile device 16, thereby providing, automatically, information to a designated Driver Pair about where, generally, the User may be located. Alternatively, the system may query the User about his or her location and the User may provide the information. This may be useful where the User's location-detection software or hardware does not work or is not activated. A pick-up location may be specified, either by the User, the designated Driver Pair, or the system itself.

At the time of pick-up, the Driver Pair may drive his or her vehicle to the pick-up location that has been predetermined and agreed upon by the parties, at which point the Driver Pair may rendezvous with the User. At this time, the system of the present invention may alert the User that the Driver Pair has arrived at the pick-up location. Other information may also be communicated to the User and/or the Driver. For example, the User may receive information concerning what kind of vehicle the Driver Pair is driving, the license plate or other identifying information, the names of the drivers, and other like information. Likewise, the Driver Pair may also receive information relating to the User, such as the User's name, appearance, vehicle make and model, license plate tag, or other like identifying information that may assist the User and/or the Driver Pair in connecting at the pick-up location. This information may be pre-entered into the system of the present invention and stored at the server for communication to the other parties as necessary. For example, information concerning the User, the Driver Pairs, their vehicles, a home address of a User, and other like information may be entered into the system during sign-up or thereafter, but prior to use of the system in the manner described herein.

At this time, a first of the drivers of the Driver Pair may exit the Driver Pair's vehicle and gain access to the User's vehicle. Of course, the User may be required to grant the first driver permission to enter and use his or her vehicle, and likely will be required to provide keys or other means of entry and utilization of the vehicle.

The User may enter the Driver Pair's vehicle, at which time a second driver of the Driver Pair may safely drive the User to his or her next destination via the Driver Pairs vehicle (such as his or her home, or to another location, as desired). The first driver of the Driver Pair, operating the User's vehicle, may drive the User's vehicle to the User's next destination. Once the first driver, driving the User's vehicle, and the second driver, driving the Driver Pair's vehicle and the User therein, arrives at the destination, the first driver may relinquish control of the User's vehicle back to the user, providing his or her keys thereto, for example, at which time the first driver may enter the Driver Pair's vehicle and the User may exit the Driver Pair's vehicle, safe at his or her next destination. The Driver Pair may then leave the User.

The Driver Pair may receive a fee from the User and/or the system of the present invention for picking up the User and driving him or her to the next destination, along with his or her vehicle. Alternatively, users may pay a subscription fee, or the system may be free to users and fees and costs may be paid for via advertising, grants, or other like monetary sources.

The User may have difficulty remembering where his or her vehicle may be located, and so the systems and methods of the present invention may assist a user in locating his or her vehicle at pick-up. Indeed, in a preferred embodiment, the User's vehicle's location may be, for convenience, the place where pick-up is designated. However, if a User cannot remember where he or she parked his or her vehicle, it may be difficult to properly implement the systems and methods herein. Therefore the present invention may provide assistance in determining where a User parked his or her vehicle.

Specifically, upon exiting his or her vehicle, the User's mobile device may query the user to flag the parked location of the User's vehicle, as illustrated in FIG. 2. Specifically, if a User determines, at the time his or her vehicle is parked, that he or she may require the services of the present invention, he or she may activate the system on his or her mobile device 16, at which time the system may request to flag the location of the vehicle. This may be done upon exiting a vehicle, whereby a User hits a virtual button or his or her screen 18 or the like confirming the vehicle's parked location on a map 19. Thus, the system may determine the User's vehicle's parked location based upon a request submitted to the User, and may store such information if necessary to be used later in determining the location of the vehicle for the first driver of the Driver Pair sent to pick-up the User and drive his or her vehicle to the User's next destination.

Alternatively, the present invention may determine, based upon various parameters, the User's vehicle's parked location. For example, the system of the present invention may utilize the User's mobile device tracking data to determine when he or she is driving the vehicle, and when he or she parks the vehicle. For example, when driving, the mobile device may detect telltale signals that he or she is driving a vehicle, such as route taken, speed, acceleration, and other like factors. Upon parking, these telltale signals may change. For example, once parked and when the User is walking, the system of the present invention may detect the change, and intuit that the User has left his or her vehicle and that it remains parked at the place where the User began walking. Thus, the present invention may intuitively determine the User's vehicle's location, even if the User does not know himself or herself.

Once the User's vehicle's location is known by the system, this information may be stored and utilized upon a Request by the User for assistance in driving, as described above. As noted above, a convenient pick-up location for both the User and the User's vehicle is the location of the User's vehicle, which may be communicated to both the User and the Driver Pair.

In another embodiment of the present invention, a User of the system of the present invention may be impaired and not realize that he or she should not be driving his or her vehicle. In such a case, the present invention may detect and automatically inform the User that a Driver Pair has been notified and activated and will arrive shortly to drive the User and his or her vehicle to the User's next destination, such as home. For example, based on mobile device tracking means and input parameters, such as audio input and video input at the User's mobile device 16, the system of the present invention may detect that the User is walking or behaving erratically, is speaking erratically, such as with slurred speech, and may determine that he or she is impaired. Alternatively, the mobile device 16, or another device in communication with the mobile device 16, may include a blood alcohol analyzer, such as, for example, a breathalyzer, that may be utilized by the User. The information gathered by the system of the present invention, such as the user's blood alcohol content, may inform the system to intuit that the User is impaired.

For example, the operation of the User's vehicle may be tied to the determination by the system whether the User is impaired. Specifically, the system may control the vehicle, and may not allow the User to operate the vehicle if the system determines that the User is impaired, as described above. At such a time, the system may automatically contact a Driver Pair to arrive at the User's vehicle to assist the User and drive the User and the User's vehicle to the next destination.

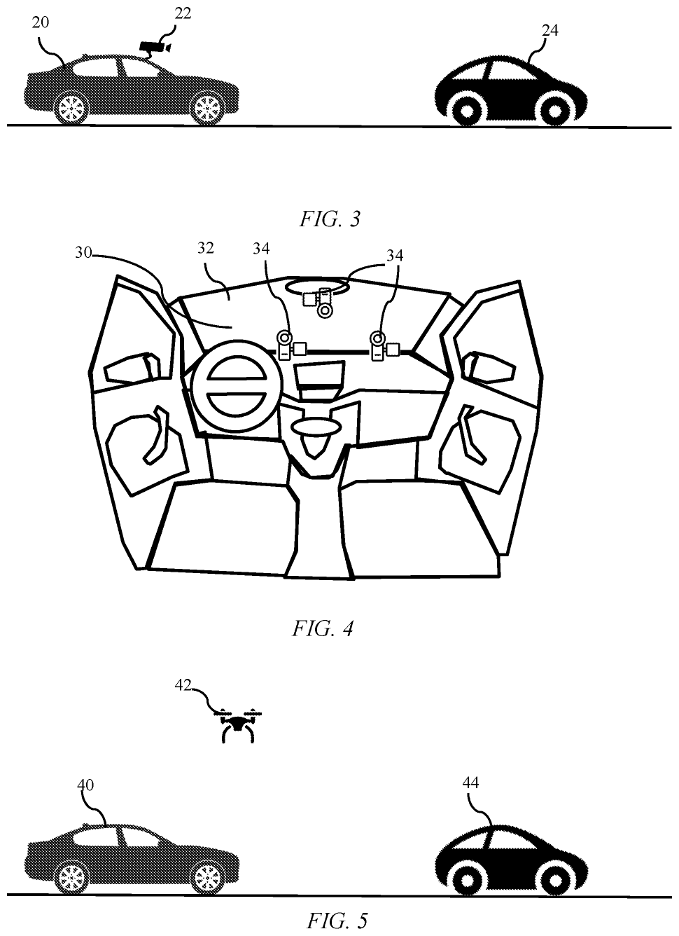

With such a system, enhanced security is necessary to ensure that neither the User nor the Driver Pairs, or their vehicles, get taken advantage of, get assaulted, injured, damaged or the like. Thus, as illustrated in FIG. 3, the Driver Pair's vehicle 20 may be equipped with one or more external cameras 22 to ensure that the User's vehicle 24 is recorded as the first driver drives the User's vehicle 24. Thus, in the example shown in FIG. 3, the Driver Pair's vehicle 20 may have the camera 22 trained on the User's vehicle 24 as the first driver drives the User's vehicle 24, thereby recording how the first driver drives the User's vehicle 24. Therefore, a record may be captured in case of damage or injuries that may occur while the first driver drives the User's vehicle 24. In a preferred embodiment, the Driver Pair's vehicle drives immediately behind the User's vehicle to ensure that the User's vehicle stays within the cameras' field of view.

Likewise, as illustrated in FIG. 4, an internal compartment 30 of the Driver Pair's vehicle 32 is illustrated. One or more cameras 34 may be situated within the internal compartment 30 of the Driver Pair's vehicle 32 to record what may occur within the Driver Pair's vehicle while the second driver drives the User to his or her next destination. Thus, a record may be captured in case of damage or injuries that may occur while the second driver drives the User within the Driver Pair's vehicle. The cameras may be portable and removable, or may be permanently mounted.

In addition, one or more portable cameras may be placed within the User's vehicle while the first driver drivers the User's vehicle to the User's next destination. The portable cameras may be set up by the first driver and activated when the first driver enters the User's vehicle to driver the User's vehicle. Alternatively, the User may already have one or more cameras placed within the User's vehicle that may already be tied and connected to the system of the present invention to capture what happens within the User's vehicle as the first driver drives the User's vehicle.

In another embodiment of the present invention illustrated in FIG. 5, as the second driver drives the Driver Pair's vehicle 40, with the User therein, a drone 42 may be activated that may be electronically tethered to the Driver Pair's vehicle so that the drone 42 follows the Driver Pair's vehicle 40, the User's vehicle 44, or one of the parties, such as the User or the first or second driver. Therefore, as the Driver Pair's vehicle 40 transports the User, and as the first driver drives the User's vehicle 44, the drone may capture and record data, such as audio data, video data, and other like data, to ensure the safety and security of the parties involved. The drone may be launched when the first driver enters the User's vehicle and may fly above both the Driver Pair's vehicle and the User's vehicle to record helpful data that may be used in case there are problems.

All information recorded by the cameras 34, as described herein, and/or by the drone 42 may be compiled and stored in the case of a claim against the User by the first or second drivers, or against the first or second drivers by the User. It is preferred that all of the parties are on camera throughout the transport of the User and the User's vehicle to enhance the safety and security of all involved. The system of the present invention may store the data captured and compiled at the server 12 for use, if necessary.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

We claim:

1. A method for assisting a driver comprising the steps of:
providing a server supporting an application, wherein the application facilitates communication between a first mobile device and a second mobile device, wherein the first mobile device is carried by a first user of the application and the second mobile device is carried by a second user of the application;
inputting location information about a first user's vehicle to the first mobile device;
accessing a communication portal at the first mobile device by the first user, wherein accessing the communication portal establishes a connection between the first mobile device and the application on the server;
sending a first communication to the application from the first mobile device requesting pick-up at a pick-up location, wherein the first communication further provides the location information about the first user's vehicle, the pick-up location, and location information about the first user's destination; and
sending a second communication from the application to the second mobile device, wherein the second mobile device is within a second vehicle comprising first and second drivers, wherein the second communication informs the second mobile device about the pick-up location, the location information about the first user's vehicle, and the location information about the first user's destination, wherein the second vehicle picks up the first user at the second location, and further wherein the first driver in the second vehicle drives the first user's vehicle from the location of the first user's vehicle to the first user's destination, and the first user rides in the second vehicle to the first user's destination driven by the second driver.

2. The method of claim 1 wherein the pick-up location is the location of the first user's vehicle.

3. The method of claim 1 wherein the location information of the first user's vehicle is manually input by the first user into the first mobile device.

4. The method of claim 1 wherein the location information of the first user's vehicle is automatically entered into the first mobile device.

5. The method of claim 4 wherein the location information of the first user's vehicle is automatically entered into the first mobile via location tracking means of the first mobile device.

6. The method of claim 4 wherein the location information of the first user's vehicle is determined by the application via information input into the first mobile device.

7. The method of claim 6 wherein the information input into the first mobile device is interpreted by the application to indicate when the first user exits the first vehicle after driving the first vehicle.

8. The method of claim 6 wherein the information input into the first mobile device comprises location information about the first mobile device, and information informing the first mobile device that the first user has parked the vehicle.

9. The method of claim 1 further comprising the step of:
automatically requesting pick-up by the second user when the application detects that the first user is impaired.

10. The method of claim 10 wherein the detection that the first user is impaired comprises analyzing first user data selected from the group consisting of location tracking information about the first user, audio data, video data, and combinations thereof.

11. The method of claim 1 further comprising the step of:
recording drive data as the first driver drives the first vehicle to the first user's destination and the second driver drives the second vehicle and the first user to the first user's destination.

12. The method of claim 11 wherein the drive data is recorded from at least one camera mounted on the second vehicle.

13. The method of claim 12 wherein the at least one camera mounted on the second vehicle is selected from the group consisting of a portable camera and a permanently mounted camera.

14. The method of claim 11 wherein the drive data is recorded from at least one camera mounted within the first vehicle.

15. The method of claim 14 wherein the at least one camera mounted within the first vehicle is selected from the group consisting a portable camera and a permanently mounted camera.

16. The method of claim 14 wherein the at least one camera mounted within the first vehicle is placed by the first driver upon entering the first vehicle.

17. The method of claim 11 wherein the drive data is recorded from at least one camera mounted within the first vehicle and at least one camera mounted within the second vehicle.

18. The method of claim 11 wherein the drive data is recorded from a drone flying above the first vehicle and the second vehicle as the first driver drives the first vehicle and the second driver drives the second vehicle.

19. The method of claim 18 wherein the drive data comprises video information from the drone.

20. The method of claim 18 wherein the drone is launched from the second vehicle when the first driver drives the first vehicle to the user's destination.
